(19) United States
(12) Patent Application Publication
(10) Pub. No.: US 2023/0388167 A1
(43) Pub. Date: Nov. 30, 2023

(54) RECEIVING AN SSB STRUCTURE

(71) Applicant: Lenovo (Singapore) Pte. Ltd., New Tech Park (SG)

(72) Inventors: Sher Ali Cheema, Llmenau (DE); Ankit Bhamri, Rödermark (DE); Ali Ramadan Ali, Kraiburg am Inn (DE); Karthikeyan Ganesan, Kronberg im Taunus (DE); Vijay Nangia, Woodridge, IL (US)

(21) Appl. No.: 18/248,853

(22) PCT Filed: Oct. 12, 2021
(86) PCT No.: PCT/IB2021/059365

§ 371 Date: Apr. 12, 2023

Related U.S. Application Data
(60) Provisional application No. 63/090,656, filed on Oct. 12, 2020.

(51) Int. Cl. H04L 27/26; H04W 48/16; H04L 5/00

(52) U.S. Cl. CPC H04L 27/261; H04L 27/26025; H04W 48/16; H04L 5/0051

(57) ABSTRACT

Apparatuses, methods, and systems are disclosed for Synchronization Signal/Physical Broadcast Channel Block (“SSB”) pattern enhancements. One apparatus includes a processor and a transceiver that receives a SSB structure comprising more than four time domain symbols. Here, the SSB structure includes at least one time domain symbol for each of a Primary Synchronization Signal (“PSS”) and a Secondary Synchronization Signal (“SSS”). The SSB structure also includes multiple time domain symbols for a Physical Broadcast Channel (“PBCH”). The processor performs cell search based on the received SSB structure and accesses a first cell based on the received SSB structure.

### CROSS-REFERENCE TO RELATED APPLICATIONS

This application claims priority to U.S. Provisional Patent Application No. 63/090,656 entitled “SSB PATTERN ENHANCEMENTS FOR HIGH SCS” and filed on Oct. 12, 2020 for Sher Ali Cheema, Ankit Bhamri, Ali Ramadan Ali, Karthikeyan Ganesan, Vijay Nangia, which application is incorporated herein by reference.

### FIELD

The subject matter disclosed herein relates generally to wireless communications and more particularly relates to Synchronization Signal/Physical Broadcast Channel (“SS/PBCH”) Block pattern enhancements for high subcarrier spacing (“SCS”).

### BACKGROUND

According to 3GPP Releases 15 and 16 (“Rel 15/16”), an SS/PBCH Block (“SSB,” also referred to as Synchronization Signal Block”) always occupies 20 Resource Blocks (“RBs”) in the frequency domain and four Orthogonal Frequency Domain Multiplexing (“OFDM”) symbols in the time domain for both Frequency Range #1 (“FR1”) and Frequency Range #2 (“FR2”). Moreover, an SSB supports up to 30 kHz of SCS for FR1 (i.e., frequencies from 410 MHz to 7125 MHz) and up to 240 kHz of SCS for FR2 (i.e., frequencies from 24.25 GHz to 52.6 GHz). Therefore, the minimum required bandwidth for User Equipment (“UE”) for initial access is different for both Frequency Ranges.

### BRIEF SUMMARY

Disclosed are procedures for SSB pattern enhancements. Said procedures may be implemented by apparatus, systems, methods, or computer program products.

One method of a User Equipment (“UE”) for SSB pattern enhancements includes receiving a SSB structure comprising more than four time domain symbols. Here, the SSB structure includes at least one time domain symbol for each of a Primary Synchronization Signal (“PSS”) and a Secondary Synchronization Signal (“SSS”). The SSB structure also includes multiple time domain symbols for a Physical Broadcast Channel (“PBCH”). The method includes performing cell search based on the received SSB structure and accessing (i.e., connecting to) a first cell based on the received SSB structure.

One method of a RAN for SSB pattern enhancements includes transmitting a SSB structure containing more than four symbols in the time domain. Here, the SSB structure includes at least one time domain symbol for each of a PSS and an SSS. The SSB structure also includes multiple time domain symbols for a PBCH. The method includes receiving a connection request from a UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for SSB pattern enhancements;

FIG. 2 is a call-flow diagram illustrating one embodiment of SSB pattern enhancements;

FIG. 3 is a diagram illustrating one embodiment of a first SSB structure;

FIG. 4A is a diagram illustrating one embodiment of a second SSB structure;

FIG. 4B is a diagram illustrating another embodiment the second SSB structure;

FIG. 5A is a diagram illustrating one embodiment of a third SSB structure;

FIG. 5B is a diagram illustrating another embodiment the third SSB structure;

FIG. 6 is a diagram illustrating one embodiment of a fourth SSB structure;

FIG. 7A is a diagram illustrating one embodiment of symbol-wise time location of the third SSB structure;

FIG. 7B is a diagram illustrating further embodiments of symbol-wise time location of the third SSB structure;

FIG. 8A a diagram illustrating one embodiment of slot-wise time location of the third SSB structure;

FIG. 8B a diagram illustrating another embodiment of slot-wise time location of the third SSB structure;

FIG. 9 a diagram illustrating one embodiment of an SSB structure with repetition of individual symbols;

FIG. 10 is a diagram illustrating another embodiment of SSB structure with individual symbol repetition;

FIG. 11 is a block diagram illustrating one embodiment of a user equipment apparatus that may be used for SSB pattern enhancements;

FIG. 12 is a block diagram illustrating one embodiment of a network apparatus that may be used for SSB pattern enhancements;

FIG. 13 is a flowchart diagram illustrating one embodiment of a first method for SSB pattern enhancements; and

FIG. 14 is a flowchart diagram illustrating one embodiment of a second method for SSB pattern enhancements.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for SSB pattern enhancements for high SCS. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In Rel 15/16, an SSB always occupies 20 RBs in the frequency domain and four OFDM symbols in the time domain for both FR1 and FR2. As used herein, an RB consists of 12 consecutive subcarriers in the frequency domain. In 5G NR, the bandwidth and the length (time domain) of the RB is not fixed, but depend on subcarrier spacing.

Moreover, an SSB supports up to 30 kHz of SCS for FR1 and up to 240 kHz of SCS for FR2. Therefore, the minimum required bandwidth for UE for initial access is different for both FR. With higher SCS and utilizing existing SSB structure, the minimum bandwidth requirements for UE will increase a lot, i.e., 115.2 MHz for 480 kHz SCS, 230.4 MHz for 960 kHz SCS, and 460.8 MHz for 1920 kHz SCS. Therefore, a higher SCS with existing SSB structure will require UEs to support wideband operations and will also increase the UE's processing power for cell search. It also limits the use of Bandwidth Parts (“BWPs”) in a cell as more resources are used for initial Bandwidth Part (“BWP”).

For supporting NR operation in both licensed and unlicensed band in the frequency range from 52.6 GHz to 71 GHz, FR2 numerologies and additional numerologies are supported. Existing framework for numerology scaling may be supported, i.e., 2^{μ}×15 subcarrier spacing to select the candidates, where the numerology is indicated by the value of μ. For SSB transmissions, μ>4 (larger than 240 kHz) may be used at the higher frequency ranges. For data and control channel transmissions, μ>3 (larger than 120 kHz) may be needed, which may impact processing timelines, Physical Downlink Control Channel (“PDCCH”) monitoring capability (Blind Decode (“BD”) and/or Control Channel Element (“CCE”)), scheduling enhancements, beam-management, and/or reference signal design.

Using the existing SSB structure, the use of SSB/CORESET multiplexing patterns in Rel 15/16 will either be limited at higher SCSs, or it will require wideband operations, or frequent frequency switching between high and low SCSs. For example, for 400 MHz bandwidth operations, the SCSs of {960, 960} kHz and {960, 480} kHz for SSB and PDCCH will limit the use of only SSB/CORESET multiplexing pattern 1. Additionally, in order to achieve a tradeoff between coverage and layer 1 overhead, the maximum number of SSBs is limited in Rel-15/16, i.e., 4 or 8 for FR1 and 64 for FR2. However, a limitation of SSB number means that a wider beam width is used to cover a certain cell area, thus sacrificing the beamforming gain and reducing the coverage.

Disclosed herein are SSB patterns for reduced bandwidth which is beneficial at high SCS. New SSB structures are proposed where the frequency and time resources of SSB structure can be adopted based on the SCS. In addition, various SSB patterns may use repetition of PSS/SSS/PBCH signals to enhance the Downlink (“DL”) coverage.

In various embodiments, the number of resource elements of PSS, SSS, and PBCH are kept the same as of SSB structure in Rel 15/16, while depending upon the SCS, the mapping of these resources in the frequency domain is done on significantly less Physical Resource Blocks (“PRBs”) to accommodate more low-end users especially at high SCSs. As used herein, a PRB consists of 12 consecutive subcarriers in the frequency domain. In 5G NR, the bandwidth and the length (time domain) of the PRB is not fixed, but depend on subcarrier spacing.

For example, with subcarrier spacing of 15 kHz, one PRB occupies 180 kHz in the frequency domain and 1 ms in the time domain. For subcarrier spacing of 30 kHz, one PRB occupies 360 kHz in the frequency domain and 0.5 ms in the time domain. For subcarrier spacing of 60 kHz, one PRB occupies 720 kHz in the frequency domain and 0.25 ms in the time domain. For subcarrier spacing of 120 kHz, one PRB occupies 1440 kHz in the frequency domain and ms in the time domain. For subcarrier spacing of 240 kHz, one PRB occupies 2880 kHz in the frequency domain and 0.0625 ms in the time domain. As the subcarrier spacing increases, the PRB bandwidth increases proportionally, and the time-domain length decreases proportionally.

In some embodiments, the Control Resource Set (“CORESET”) minimum bandwidth requirements for high SCSs are reduced to the size of SSB structures to limit the initial BWP, whereas the time domain resources are increased to allow configuration of existing PDCCH configurations. SSB/CORESET Multiplexing patterns 2 and 3 can be employed at high SCS with different configurations.

With the use of proposed SSB structures, the number of SSB beams may also be increased from 64 to 128 without the need of sacrificing the PBCH payload bits, thus full beamforming gain can be achieved at higher frequencies and higher SCSs. Depending upon the coverage requirements, different time domain mapping patters at symbol and slot level can be realized.

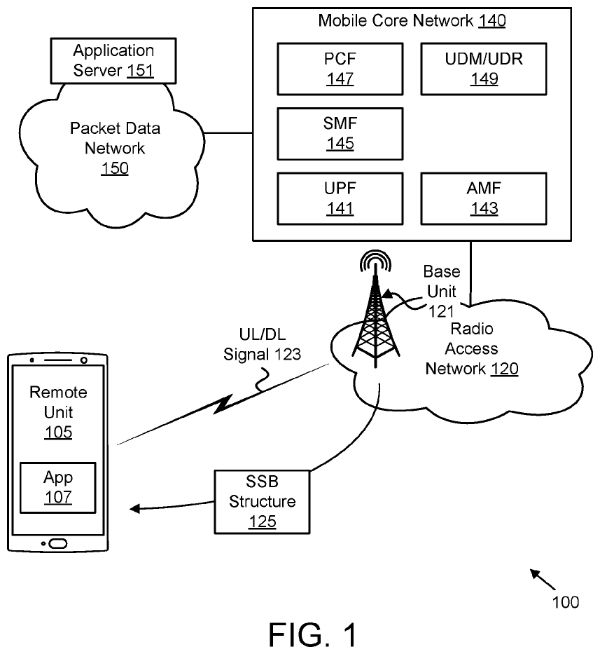

FIG. 1 depicts a wireless communication system 100 for SSB pattern enhancements, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In various embodiments, the remote unit 105 receives an SSB structure 125 from the base unit 121. As described in greater detail below, the specific SSB structure 125 may depend on a numerology and/or subcarrier spacing for the frequency range in which the remote unit 105 and base unit 121 are operating.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”, also referred to as “Unified Data Repository”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Stratum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the Fifth Generation Core network (“5GC”). When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for SSB pattern enhancements apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), Access Point (“AP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for SSB pattern enhancements.

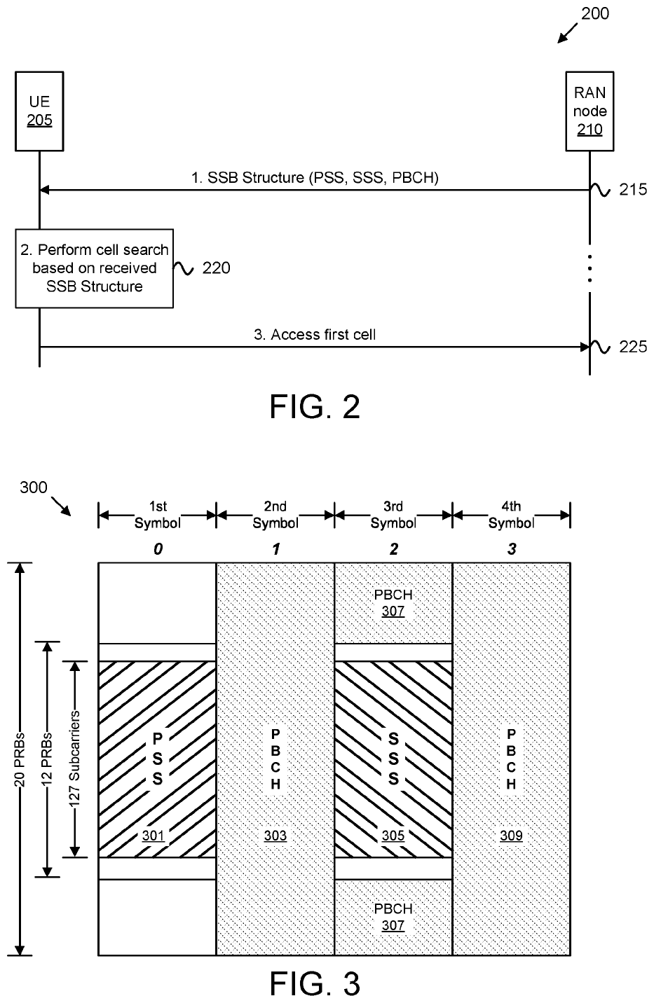

FIG. 2 depicts a first procedure 200 for SSB pattern enhancements, according to embodiments of the disclosure. The first procedure involves a UE 205 and a RAN node 210, such as a gNB. The UE 205 may be one embodiment of the remote unit 105, while the RAN node 210 may be one embodiment of the base unit 121.

As depicted, at Step 1 the UE 205 may receive an SSB structure from the RAN node 210 (see messaging 215). As described in further detail below, the SSB structure occupied multiple time-domain symbols and includes a PSS, an SSS, PBCH. RAN node.

At Step 2, the UE 205 performs cell search based on the received SSB structure (see block 220).

At Step 3, based on the cell search the UE 205 accesses a first cell (i.e., provided/supported by the RAN node 210), e.g., using information in the received SSB structure (see messaging 225).

FIG. 3 depicts a time/frequency structure 300 of a single SSB transmission, referred to as SSB Type 1. In NR, the primary and secondary synchronization signals are used by the UE for initial cell search and to obtain frame timing, Cell ID, and to find the reference signals for coherent demodulation of other channels. SSB transmission is based on OFDM that is transmitted on a set of time/frequency resources (resource elements) within the basic OFDM grid and using the same numerology.

As can been seen, an SS/PBCH block consists of four OFDM symbols in the time domain, numbered in increasing order from 0 to 3 within the SSB, where PSS 301, SSS 305, and PBCH 303, 307, 309 with the associated DMRS are mapped to symbols, e.g., according to Table 1. In the frequency domain, an SS/PBCH block consists of 240 contiguous subcarriers (i.e., 20 PRBs) with the subcarriers numbered in increasing order from 0 to 239 within the SS/PBCH block. The quantities k and l represent the frequency and time indices, respectively, within one SS/PBCH block. The quantity v in Table 1 is given by v=N_{ID}^{cell} mod 4. The total number of resource elements (“REs”) used for PBCH with the associated DMRS per SSB equals to 576 (i.e., 240 REs from PBCH 303, 96 REs from PBCH 307, and 240 REs from PBCH 309), while PSS and SSS each occupy 127 resource elements. As used herein, a Resource Element (“RE”) is defined as one subcarrier over one time-domain symbol. There are two types of SSBs, that is, Type A and Type B, where the former is specified for operation in sub-6 GHz frequency range with SCS of 15 kHz and 30 kHz and the latter is defined for FR2 bands with SCS options of 120 kHz and 240 kHz.

TABLE 1
Resources within an SSB for PSS,
SSS, PBCH, and DMRS for PBCH

| | OFDM symbol number/ | |
|---|---|---|
| Channel | relative to the start | Subcarrier number k relative |
| or signal | of an SS/PBCH block | to the start of an SS/PBCH block |
| PSS | 0 | 56, 57, . . . , 182 |
| SSS | 2 | 56, 57, . . . , 182 |
| Set to 0 | 0 | 0, 1, . . . , 55, 183, |
| | | 184, . . . , 239 |
| | 2 | 48, 49, . . . , 55, 183, |
| | | 184, . . . , 191 |
| PBCH | 1, 3 | 0, 1, . . . , 239 |
| | 2 | 0, 1, . . . , 47, |
| | | 192, 193, . . . , 239 |
| DMRS | 1, 3 | 0 + v, 4 + v, 8 + v, . . . , 236 + v |
| for | 2 | 0 + v, 4 + v, 8 + v, . . . , 44 + v |
| PBCH | | 192 + v, 196 + v, . . . , 236 + v |

The maximum number of SSBs (Lmax) differ for different frequency range, i.e., Lmax=4 for FR1<3 GHz, Lmax=8 for 3 GHz<FR1<6 GHz, and Lmax=64 for FR2. The SSBs are indexed in an ascending order in time within a half frame from 0 to Lmax−1. Within the SSB indices, two or three Least Significant Bits (“LSBs”) are carried by changing the Demodulation Reference Signal (“DMRS”) sequence of PBCH. Thus, for the sub-6 GHz frequency range, the UE can acquire the SSB index without decoding the PBCH. A UE determines the 2 LSBs, for Lmax=4, or the 3 LSBs, for Lmax>4, of an SSB index per half frame from a one-to-one mapping with and index of the DMRS sequence transmitted in the PBCH. For Lmax=64, the UE determines the 3 Most Significant Bits (“MSBs”) of the SSB index per half frame from the PBCH payload bits.

In this disclosure, the SSB structure is adapted in time-frequency domain depending upon the frequency band and/or subcarrier spacing (numerology) such that the number of the frequency resources for at least one of the PSS, SSS or PBCH is adjusted to increase or decrease the resources in frequency and correspondingly decrease or increase the time symbols. In Table 2 below, an example is shown where the number of time-frequency resources for different signals/channels in SSB is mapped according to subcarrier spacing in specific frequency bands. Other combinations could be assumed/applied as well.

The new SSB structures for high SCSs are beneficial to enhance the DL coverage and to accommodate low-end UEs for initial cell search. Basically, the PSS, SSS, and PBCH payload/structure is kept the same, however, the mapping to OFDM symbols is changed by increasing the PBCH symbols. For example, the frequency resources for PBCH can be reduced and number of symbols in time domain are increased to allow for UEs to have initial search procedure with relatively lower BWP range. The key benefits of the proposed SSB structure include:
1. The initial BWP requirements for UE is reduced, thus low end UEs, that cannot afford wideband operations, can still operate especially at high SCS.
2. Number of SSB beams are increased, thus enhancing the overall DL coverage.
3. Rel 15/16 multiplexing patterns can still be employed at higher SCS.

TABLE 2
Example of mapping SSB time-frequency
distribution as a function of SCS

| SSB Format | Subcarrier | | | |
|---|---|---|---|---|
| type | Spacing | PSS | SSS | PBCH |
| Type 1 | 240 kHz | 1 symbol, | 1 symbol, | 3 symbols, |
| | | 11 PRBs | 11 PRBs | 20 (+8) PRBs |
| Type 2 | 480 kHz | 1 symbol, | 1 symbol, | 3 symbols, |
| | | 11 PRBs | 11 PRBs | 16 PRBs |
| Type 3 | 960 kHz | 1 symbol, | 1 symbol, | 4 symbols, |
| | | 11 PRBs | 11 PRBs | 12 PRBs |
| Type 4 | 1920 kHz | 2 symbols, | 2 symbols, | 8 symbols, |
| | | 6 PRBs | 6 PRBs | 6 PRBs |

In the following embodiments of SSB pattern enhancements are described. It is understood that the disclosure is not limited to the embodiments individually, and one or more elements from one or more embodiments may be combined.

According to embodiments of a first solution, depending upon the SCSs, frequency range, and initial BWP requirements, the SSB structure is mapped on the time-frequency grid in such a way that total number of resource elements for SSS, PSSS, and PBCH including DMRS remain the same while the number of PRBs and the number of time domain symbols for PBCH are varied. This is beneficial where different structures can be associated with different SCS, bandwidth configurations, and frequency ranges.

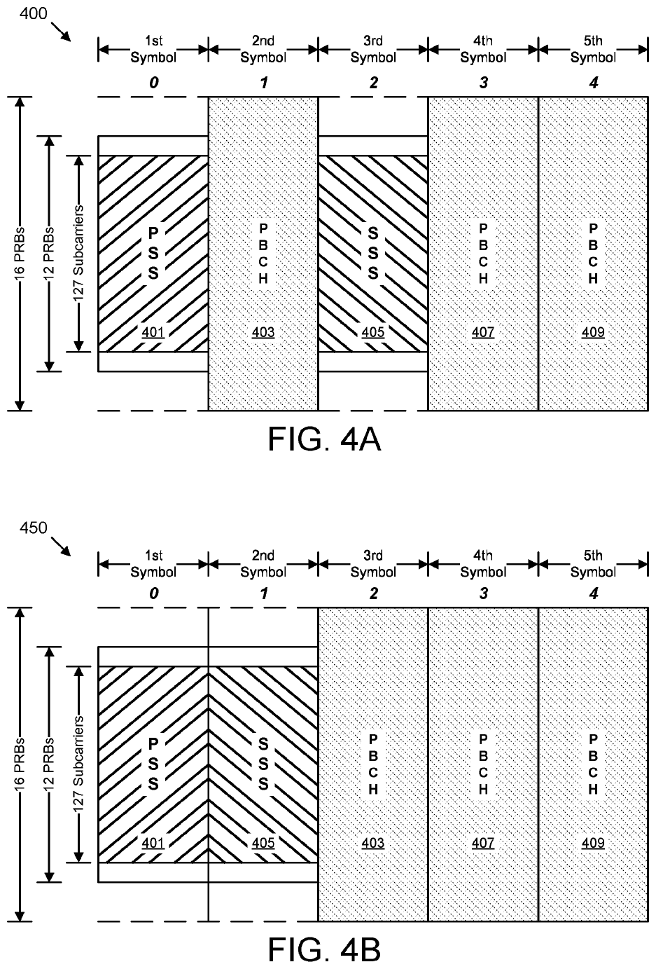

FIG. 4A depicts one implementation of a SSB structure 400, referred to as SSB Type 2. In the time domain, the SSB type 2 consists of 5 OFDM symbols, numbered in increasing order from 0 to 4 within the SSB structure 400, i.e., one symbol for PSS 401, one symbol for SSS 405, and three symbols for PBCH 403, 407 and 409. In the depicted embodiment, the PSS 401 is located in the first time domain symbol, the PBCH 403 is located in the second time domain symbol, the SSS 405 is located in the third time domain symbol, and PBCH 407, 409 are located in the fourth and fifth symbols, respectively. In some embodiments, the first and third symbols are extended in the frequency domain with PBCH on either side of the PSS 401 and/or SSS 405 to occupy a minimum of 16 RBs.

FIG. 4B depicts another implementation of SSB structure 500 of SSB Type 2. Again, the SSB Type 2 consists of 5 OFDM symbols, numbered in increasing order from 0 to 4 within the SSB structure 450. As depicted, the location of SSS 405 and PBCH are flexible, such that SSS 405 may be located in the second time domain symbol and PBCH 403 located in the third time domain symbol. In other embodiments, the PSS 401 is located in the first time domain symbol, the SSS 405 may be located in any of the third, fourth or fifth time domain symbols, with the PBCH occupying the remaining symbols (e.g., OFDM symbols). In some embodiments, the first and second symbols are extended in the frequency domain with PBCH on either side of the PSS 401 and/or SSS 405 to occupy a minimum of 16 RBs.

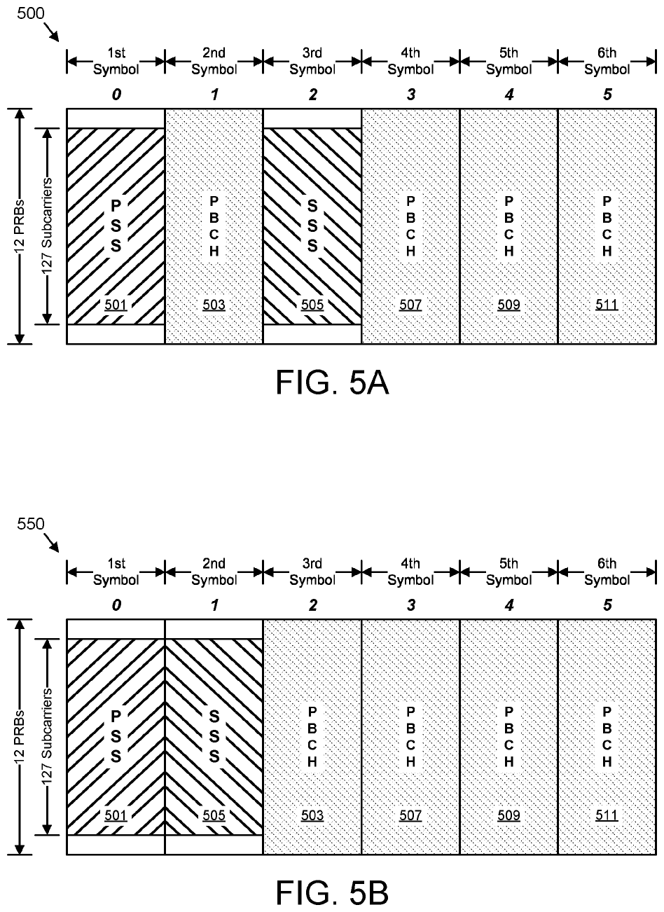

FIG. 5A depicts one implementation of a SSB structure 500, referred to as SSB Type 3. In one example, the 4 RBs in the frequency domain (e.g., 2 RBs on either side) of the PSS 501 and/or SSS 405 symbols are also used for PBCH. In the time domain, the SSB type 3 consists of 6 OFDM symbols, numbered in increasing order from 0 to 5 within the SSB structure 500, i.e., one symbol for PSS, one symbol for SSS, and four symbols for PBCH 503, 507, 509 and 511. In the depicted embodiment, the PSS 501 is located in the first time domain symbol, the PBCH 503 is located in the second time domain symbol, the SSS 505 is located in the third time domain symbol, and PBCH 507, 509 and 511 are located in the fourth, fifth and sixth symbols, respectively.

FIG. 5B depicts another implementation of SSB structure 550 of SSB Type 3. Again, the SSB Type 3 consists of 6 OFDM symbols, numbered in increasing order from 0 to 5 within the SSB structure 550. As depicted, the location of SSS 505 and PBCH are flexible, such that SSS 505 may be located in the second time domain symbol and PBCH 503 located in the third time domain symbol. In other embodiments, the PSS 501 is located in the first time domain symbol, the SSS 505 may be located in any of the third, fourth, fifth or sixth time domain symbols, with the PBCH occupying the remaining symbols (e.g., OFDM symbols).

Depending upon the system requirements, SSB Type 2 and Type 3 can be associated with different SCSs. For example, SSB Type 2 can be used for 480 kHz where system configuration allows for RB difference of up to 5 between PSS, SSS, and PBCH, whereas SSB Type 3 can be used for 960 kHz where RB difference of 1 is allowed. Moreover, the position of SSS and PBCH in the time domain can also be changed according to system/design requirements. For instance, SSS can be located at OFDM symbol position 3 for SSB Type 3, i.e., in between two PBCH OFDM symbols.

The PSS, SSS, and PBCH with associated DMRS are mapped to symbols as given by Table 3. In the frequency domain, an SSB Type 2 consists of 192 contiguous subcarriers while the SSB Type 3 consists of 144 subcarriers. The quantities k and l represent the frequency and time indices, respectively, within one SSB. The UE may assume that the complex-valued symbols corresponding to resource elements denoted as ‘Set to 0’ in Table 2 are set to zero. The quantity v in Table 2 is given by v=N_{ID}^{cell} mod 4. The total number of resource elements used for PBCH with the associated DMRS per SSB still equals to 576 (as for SSB Type 1) while PSS and SSS occupies 127 resource elements (as for SSB Type 1). Specifically, the number of REs used for PBCH in SSB Type 2 comprises 192×3, while the number of REs used for PBCH in SSB Type 3 comprises 144×4. In an alternative implementation, for both SSB Type 1 and SSB Type 2, the DMRS resource elements of PBCH are mapped to one OFDM symbol, such that the number of the PBCH RBs can be further reduced.

TABLE 3
Resources within an SSB for PSS,
SSS, PBCH, and DMRS for PBCH

| | OFDM symbol | | | |
|---|---|---|---|---|
| | number/relative | | | |
| | to the start of | | | |
| | an SSB | | Subcarrier number k relative | |
| Channel | SSB | SSB | to the start of an SSB | |
| or signal | Type 2 | Type 3 | SSB Type 2 | SSB Type 3 |
| PSS | 0 | 0 | 32, 33, . . . , 158 | 8, 10, . . . , 134 |
| SSS | 2 | 2 | 32, 33, . . . , 158 | 8, 10, . . . , 134 |
| Set to 0 | 0 | 0 | 0, 1, . . . , 31, | 0, 1, . . . , 7, |
| | | | 159, . . . , 191 | 136, . . . , 143 |
| | 2 | 2 | 0, 1, . . . , 31, | 0, 1, . . . , 7, |
| | | | 159, . . . , 191 | 136, . . . , 143 |
| PBCH | 1, 3, 4 | 1, 3, | 0, 1, . . . , 191 | 0, 1, . . . , 143 |
| | | 4, 5 | | |
| DMRS for | 1, 3, 4 | 1, 3, | 0 + v, 4 + v, 8 + | 0 + v, 4 + v, 8 + |
| PBCH | | 4, 5 | v, . . . , 188 + v | v, . . . , 140 + v |

In Table 4, SSB duration and bandwidth requirements for the above SSB types are summarized. The SSB Type 3 has significantly lower bandwidth requirements as compared to SSB Type 1 especially at higher SCSs. The symbol duration for SSB Type 3 is slightly larger than SSB Type 1 as it comprises of 6 OFDM symbols. Since, the number of slots is also increased for higher SCSs due to shorter symbol duration, all SSB beams for SSB Type 2 and SSB Type 3 can be easily accommodated in 5 ms half frame duration.

TABLE 4
SSB Numerologies with Corresponding Bandwidths and Durations

| | Number | SSB Type 1 | | SSB Type 2 | | SSB Type 3 | |
|---|---|---|---|---|---|---|---|
| | of slots | SSB | SSB | SSB | SSB | SSB | SSB |
| Numerology | per | Duration | Bandwidth | Duration | Bandwidth | Duration | Bandwidth |
| (kHz) | Subframe | (μs) | (MHz) | (μs) | (MHz) | (μs) | (MHz) |
| 240 | 16 | ≈18 | 57.6 | ≈22.2 | 46.08 | ≈26.64 | 34.56 |
| 480 | 32 | ≈9 | 115.2 | ≈11.1 | 92.16 | ≈13.32 | 69.12 |
| 960 | 64 | ≈4.5 | 230.4 | ≈5.55 | 184.32 | ≈6.66 | 138.24 |
| 1920 | 128 | ≈2.2 | 460.8 | ≈2.8 | 368.64 | ≈3.33 | 276.48 |

According to embodiments of a second solution, the number of symbols for either PSS or SSS or both of them is more than one such the frequency resources for even the synchronization signal is reduced and consequently the number of time domain symbols for SSB are further increased. For instance, the PSS can be configured by two short sequences mapped to half of the required RBs (e.g., 64 sub-carriers each), indicating a subset of IDs N⁽²⁾_{ID}. For example, PSS1 carries the IDs (0, 1) and PSS2 carries the ID (2). The UE first search for synchronization using PSS1, if it is not there, it looks in PSS2. The SSS can also be configured with two short sequences mapped on two symbols, e.g., SSS1 carries the IDs N⁽¹⁾_{ID}(0-167), while SSS2 carries the IDs (168-335). The RAN node sends its IDs only on one of the PSS/SSS symbols.

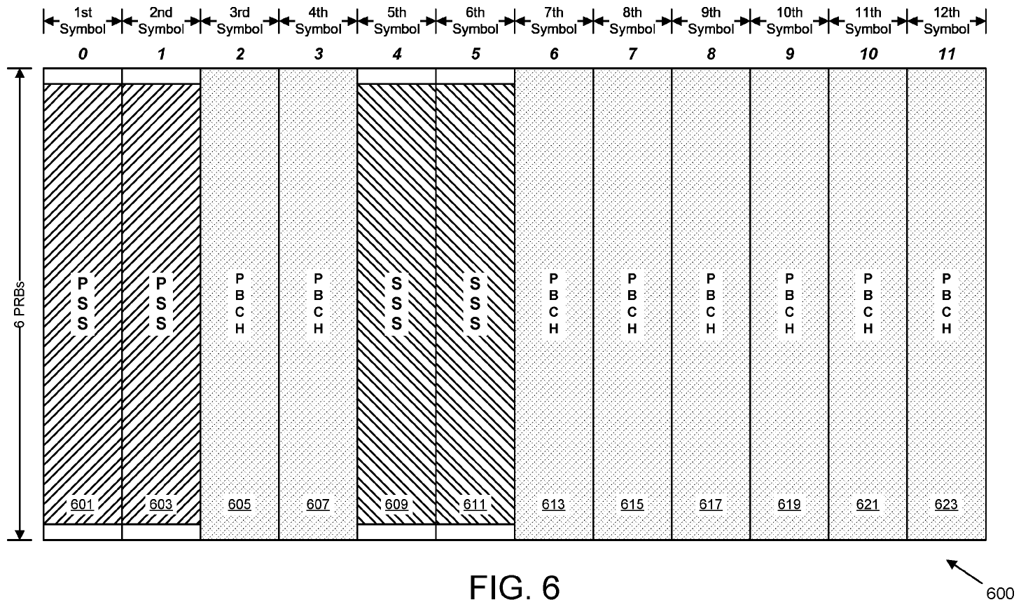

FIG. 6 depicts one implementation of a SSB structure 600, referred to as SSB Type 4, according to the concepts of the second solution. In the depicted embodiment, the first PSS (“PSS1”) 601 is located in the first time domain symbol, the second PSS (“PSS2”) 603 is located in the second time domain symbol, the PBCH 605 is located in the third time domain symbol, the PBCH 607 is located in the fourth time domain symbol, the first SSS (“SSS1”) 609 is located in the fifth time domain symbol, the second SSS (SSS2) 611 is located in the sixth time domain symbol, and PBCH 613, 615, 716, 619, 621 and 623 are located in the seventh through twelfth symbols, respectively. Such SSB configuration can be employed for very high SCS such as 1920 kHz, where deploying larger number of symbols for SSB transmission could be considered. Basically, different SSB patterns ranging from 4 symbols in current NR to 14 symbols as an enhancement can be considered. In some symbols, frequency multiplexing of PBCH with SSS and/or PSS can be considered.

In another implementation of the second solution, three symbols for PSS are utilized, wherein the PSS sequence length is half of the PSS length in NR and N⁽²⁾_{ID}=0, N⁽²⁾_{ID}=1, and N⁽²⁾_{ID}=2 are associated with PSS1 on symbol 1, PSS2 on symbol 2 and PSS3 on symbol 3, respectively. The number of PRBs for each symbol can be 6.

In an alternate implementation, the number of N⁽²⁾_{ID} values is different than 3 and correspondingly the number of N⁽¹⁾_{ID} is also changed to allow similar number of cell IDs that can be currently indicated by a combination of PSS and SSS. For example, two PSS symbols and two SSS symbols are transmitted. PSS1 on symbol 1 can be associated with N⁽²⁾_{ID}=0,1 and PSS2 on symbol 2 can be associated with N⁽²⁾_{ID}=2,3. Consequently, N⁽¹⁾_{ID} (0-123) is associated with SS1 and N⁽¹⁾_{ID} (126-251) is associated with SS2. Based on this, the cell ID can be calculated as N_{ID}^{Cell}=4×N_{ID}⁽¹⁾+N_{ID}⁽²⁾ to support up to 1012 cell IDs.

In another implementation, the Rel-15 NR PSS/SSS sequence of length-127 (or in general, a length-N sequence) is split in to two sub-sequences and mapped to the two PSS/SSS symbols. In one example, the length-127 sequence is split into a length-64 first sub-sequence, with sequence elements n=0 . . . 63 which is mapped to subcarriers k=4 to 67 in the first symbol, and a second sub-sequence with sequence elements n=64 . . . 127 which is mapped to subcarriers k=4 to 66 in the second symbol. In another example, the length-127 sequence is split into a length-64 first sub-sequence, with sequence elements n=0 . . . 63 which is mapped to subcarriers k=4 to 67 in the first symbol, and a second sub-sequence with sequence elements n=64 . . . 127 which is mapped to subcarriers k=67 down to k=5 in the second symbol. Thus, on a subcarrier (k=67) on first symbol and second symbol adjacent sequence elements (n=63, 64) of length-127 sequence are mapped.

According to embodiments of a third solution, the minimum bandwidth of a Type Control Resource Set (“CORESET 0”) is set equal to SSB bandwidth, i.e., 12 PRBs for SSB Type 3 and 16 PRBs for SSB Type 2. This will allow initial BWP equals to the SSB bandwidth, thus facilitating the low-end UEs. To accommodate the different PDCCH configurations, the CORESET_0 can be extended in the time domain, for example up to 6 OFDM symbols for SSB Type 2,3 (even higher number of symbols could be considered depending up on the number of symbols for SSB). In this case, the bandwidth requirement for system information delivery using multiplexing pattern 1 for SSB Type 2 and SSB Type 3 will always be equal to SSB bandwidths (in Table 4). With multiplexing pattern 2 and 3, the required bandwidth will be different depending upon the CORESET configurations for different subcarrier spacings. As an example, different multiplexing patterns with high SCS that are currently not supported in Rel 15/16 are summarized in Table 5.

TABLE 5
Example of Bandwidth Requirements for SSB Type 2 and CORESET_0 Multiplexing
Patterns 2 and 3

| | | | CORESET | | | | | Total | |
|---|---|---|---|---|---|---|---|---|---|
| | | | Bandwidth | | SSB Bandwidth | | | Bandwidth | |
| | Multiplexing | | (MHz) | | (MHz) | | | (MHz) | |
| | pattern {SSB, | N_{RB}^{CORESET} | SSB | SSB | SSB | SSB | Gap | SSB | SSB |
| | PDCCH} KHz | PRBs | Type 2 | Type 3 | Type 2 | Type 3 | PRBs | Type 2 | Type 3 |
| Pattern | {480, 240} | N_{RB}^{SSB} | 46.08 | 34.56 | 92.16 | 69.12 | 2 | 144 | 109.44 |
| 2 | | (16/12) | | | | | | | |
| | {480, 240} | 24 | 69.12 | 69.12 | 92.16 | 69.12 | 2 | 167.04 | 144 |
| | {960, 480} | N_{RB}^{SSB} | 92.16 | 69.12 | 184.32 | 138.24 | 2 | 288 | 218.88 |
| | | (16/12) | | | | | | | |
| | {960, 480} | 24 | 138.24 | 138.24 | 184.32 | 138.24 | 2 | 334.08 | 288 |
| Pattern | {480,480} | N_{RB}^{SSB} | 92.16 | 69.12 | 92.16 | 69.12 | 2 | 195.84 | 149.76 |
| 3 | | (16/12) | | | | | | | |
| | {480,480} | 24 | 138.24 | 138.24 | 92.16 | 69.12 | 2 | 241.92 | 218.88 |
| | {960,960} | N_{RB}^{SSB} | 184.32 | 138.24 | 184.32 | 138.24 | 2 | 391.68 | 299.52 |
| | | (16/12) | | | | | | | |

According to embodiments of a fourth solution, the maximum number of SSB beams are increased up to 128 using the SSB structure. PBCH DMRS pseudo-random sequence of each of four PBCH OFDM symbols in SSB Type 3 or group of PBCH symbols in case SSB Type 4 is initialized differently with 4 LSB of SSB Index. This gives the opportunity to code up to 16 SSB indices (2 4=16). Combining these with 3 MSB of PBCH payload bits, in total up to 128 SSB indices can be coded (2⁴+2³=128). In Rel 15/16, five cases (A-E) of time pattern of SSB blocks are considered with maximum SCS of 240 kHz and maximum of 64 beams for SSB Type 1. In one implementation, new cases for higher SCSs can be implemented.

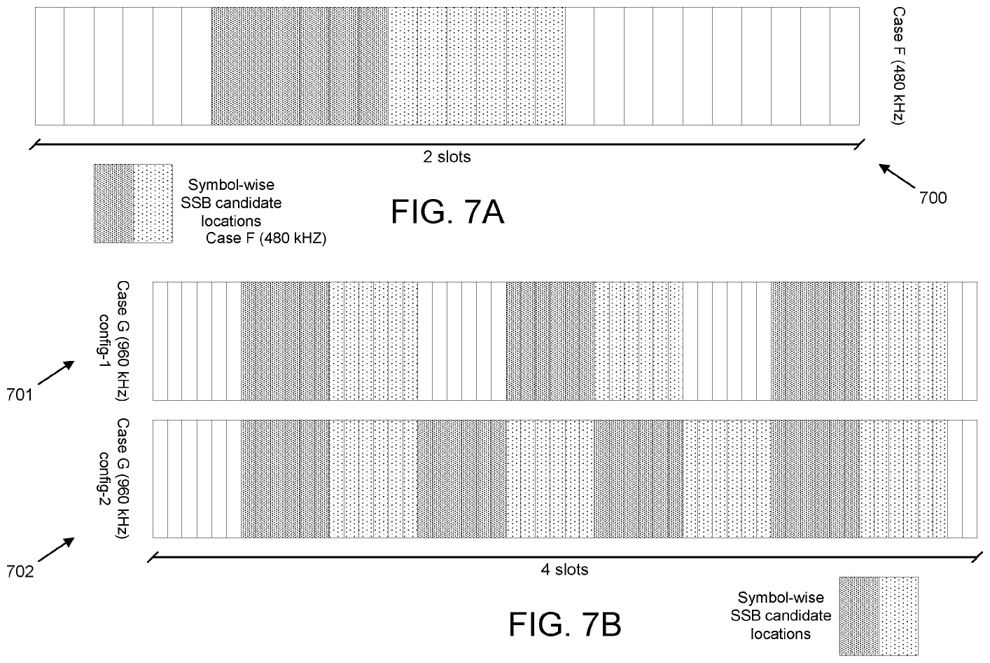

FIG. 7A depicts one example of symbol-wise time location of SSB Type 3, showing time pattern of the Case F having SCS of 480 kHz. Pattern 700 shows symbol-wise SSB candidate locations for Case F, where there is one SSB per slot. In the depicted embodiment, there are 14 symbols (labeled from 0 to 13) per slot.

FIG. 7B depicts one example of symbol-wise time locations of SSB Type 3, showing time pattern of two cases of the Case G having SCS of 960 kHz. Pattern 701 shows symbol-wise SSB candidate locations for Case G, Configuration 1 (“config-1”), where there is one SSB per slot. Pattern 702 shows symbol-wise SSB candidate locations for Case G, Configuration 1 (“config-1”), where there are 8 SSBs per 4 slots.

Similarly, the SSB locations within a half-frame are also determined in a slot level for each SCS. To have compatibility with the cases A-E, in one implementation, the repetition at slot level can be kept in the same order as for cases A-E.

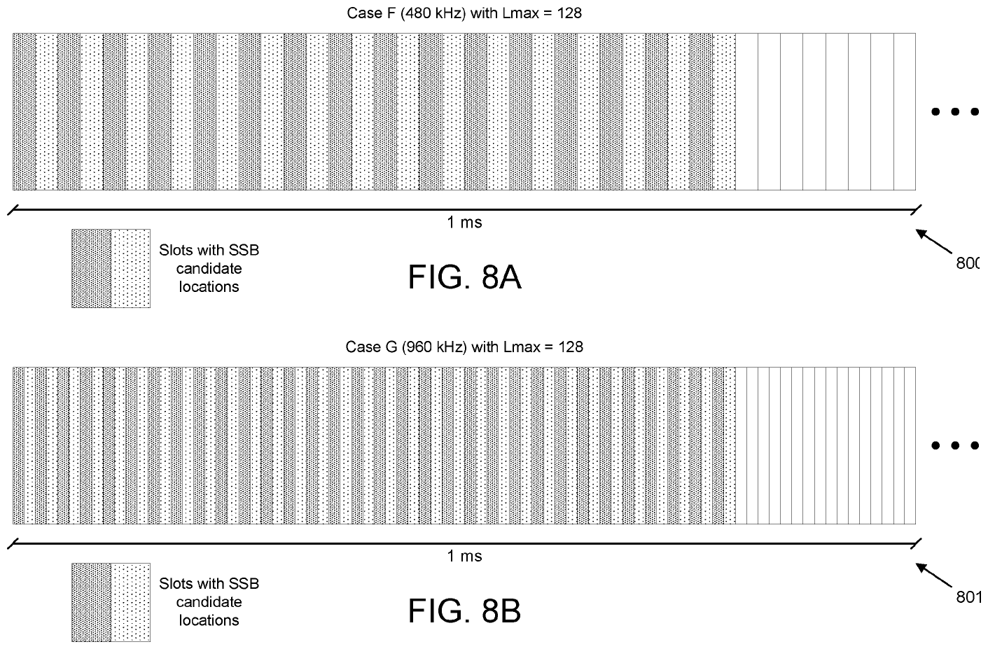

FIG. 8A depicts one example of slot-wise time location of SSB Type 3, showing the Case F for SCS of 480 kHz.

FIG. 8B depicts one example of slot-wise time location of SSB Type 3, showing the Case G for SCS of 960 kHz. Similar symbol-wise and slot-wise time pattern for other SSB types can be configured.

In one example, the set of SSB within a beam sweep, i.e., SSB burst set, is confined to a 2.5 ms time interval—in the first or second half of a first or second half-frame (of a 10 ms frame) compared to a 5 ms time interval, either in the first or second half of a 10 ms frame for Rel-15/16—for at least on SSB Type due to higher SCS usage (more slots in a 1 ms subframe) for SSB. The minimum periodicity of the Synchronization Signal (“SS”) burst set is with a minimum period of 2.5 ms and a maximum period of 80/160 ms.

According to embodiments of a fifth solution, depending upon the bandwidth, SSS or PSS or PBCH or SSB can be repeated in the frequency and/or time domain to enhance the coverage.

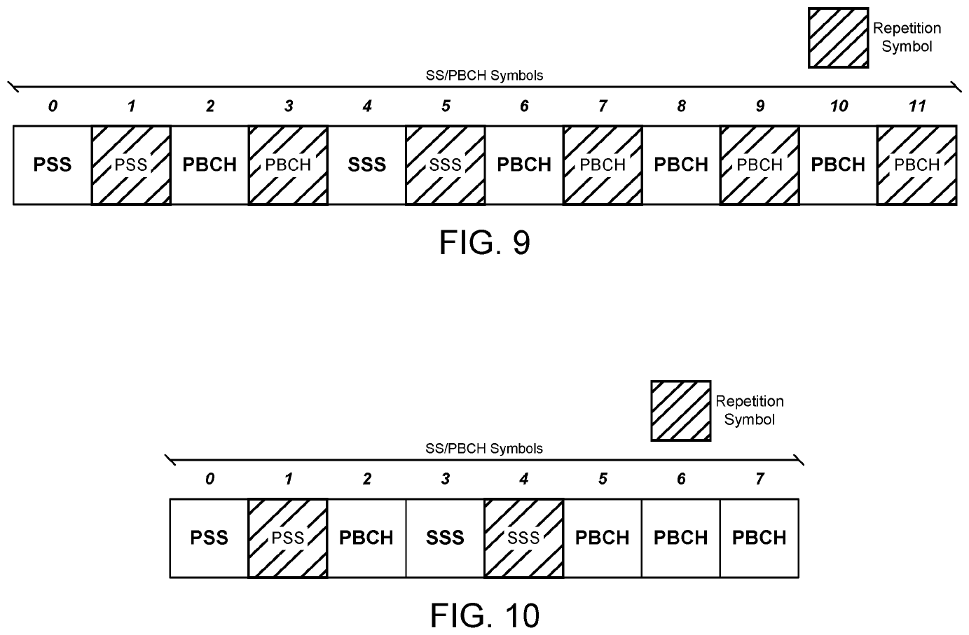

FIG. 9 depicts an example of same repetition of individual symbols of SSB Type 3. Here, the PSS, SSS, and PBCH symbols are all repeated.

FIG. 10 depicts another example of individual symbol repetition for SSB Type 3. Here, only the PSS and SSS symbols are repeated.

In one implementation, contiguous repetition (using same beam) of SSB in time domain is supported, where, the first transmission occasions for SSB is followed by second transmission occasion for SSB. Number of contiguous repetitions for an SSB block can be pre-configured depending up on the frequency range and/or subcarrier spacing.

In another implementation, each signal/channel within SSB is individually repeated. For instance, based on the network deployment, the cell IDs can be pre-configured with different repetition factors. For example, for repetition factor 1, with SSB Type 3 proposes, 1^{st} symbol is PSS transmission occasion 1, 2^{nd} symbol is PSS transmission occasion 2, 3^{rd} symbol is PBCH transmissions occasion 1, 4^{th} symbol is PBCH transmissions occasion 2, 5^{th} symbol is SSS transmission occasion 1, 6^{th} symbols is SSS transmission occasion 2, 7^{th}, 9^{th}, and 11^{th} symbols are remaining PBCH transmission occasion 1 while 8^{th}, 10^{th}, and 12^{th} symbols are remaining transmission occasion 2.

In other implementations, number of repetitions for each of the signal/channel within an SSB block can be pre-configured individually. For example, it could be that only PSS or SSS or both are configured with repetitions, while PBCH are not configured with any repetition.

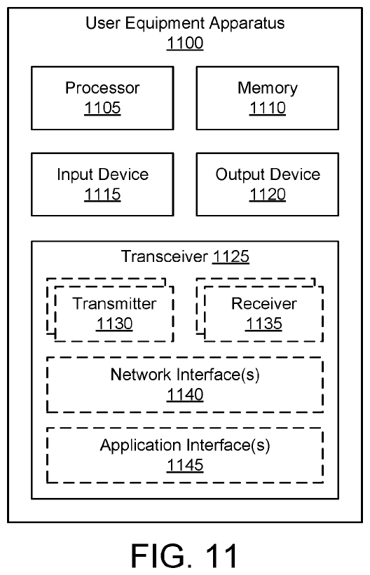

FIG. 11 depicts a user equipment apparatus 1100 that may be used for SSB pattern enhancements, according to embodiments of the disclosure. In various embodiments, the user equipment apparatus 1100 is used to implement one or more of the solutions described above. The user equipment apparatus 1100 may be one embodiment of the remote unit 105 and/or the UE 205, described above. Furthermore, the user equipment apparatus 1100 may include a processor 1105, a memory 1110, an input device 1115, an output device 1120, and a transceiver 1125.

In some embodiments, the input device 1115 and the output device 1120 are combined into a single device, such as a touchscreen. In certain embodiments, the user equipment apparatus 1100 may not include any input device 1115 and/or output device 1120. In various embodiments, the user equipment apparatus 1100 may include one or more of: the processor 1105, the memory 1110, and the transceiver 1125, and may not include the input device 1115 and/or the output device 1120.

As depicted, the transceiver 1125 includes at least one transmitter 1130 and at least one receiver 1135. In some embodiments, the transceiver 1125 communicates with one or more cells (or wireless coverage areas) supported by one or more base units 121. In various embodiments, the transceiver 1125 is operable on unlicensed spectrum. Moreover, the transceiver 1125 may include multiple UE panels supporting one or more beams. Additionally, the transceiver 1125 may support at least one network interface 1140 and/or application interface 1145. The application interface(s) 1145 may support one or more APIs. The network interface(s) 1140 may support 3GPP reference points, such as Uu, N1, PC5, etc. Other network interfaces 1140 may be supported, as understood by one of ordinary skill in the art.

The processor 1105, in one embodiment, may include any known controller capable of executing computer-readable instructions and/or capable of performing logical operations. For example, the processor 1105 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 1105 executes instructions stored in the memory 1110 to perform the methods and routines described herein. The processor 1105 is communicatively coupled to the memory 1110, the input device 1115, the output device 1120, and the transceiver 1125.

In various embodiments, the processor 1105 controls the user equipment apparatus 1100 to implement the above described UE behaviors. In certain embodiments, the processor 1105 may include an application processor (also known as “main processor”) which manages application-domain and operating system (“OS”) functions and a baseband processor (also known as “baseband radio processor”) which manages radio functions.

In various embodiments, the processor 1105 receives (i.e., via the transceiver 1125 implementing a radio interface) a Synchronization Signal/Physical Broadcast Channel Block (“SSB”) structure comprising more than four time domain symbols. Here, the SSB structure includes at least one time domain symbol for each of a PSS and an SSS. The SSB structure also includes multiple time domain symbols for a PBCH. The processor 1105 performs cell search based on the received SSB structure and accesses (i.e., connects to) a first cell based on the received SSB structure.

In some embodiments, the SSB structure (e.g., SSB Type 2) occupies five OFDM symbols in the time domain, and 192 REs in the frequency domain, where the SSB structure contains one OFDM symbol for the PSS, one OFDM symbol for the SSS, and three OFDM symbols for the PBCH. In certain embodiments, the PSS and SSS occupy a same number of RBs in frequency, where the PBCH occupies at least as many RBs in frequency as the PSS (or SSS). In one embodiment, the PBCH occupies one RB more than the PSS (or SSS) in frequency.

In some embodiments, the SSB structure (i.e., SSB Type 3) occupies six OFDM symbols in the time domain, and 144 resource elements in the frequency domain, where the SSB structure contains one OFDM symbol for the PSS, one OFDM symbol for the SSS, and four OFDM symbols for the PBCH.

According to the above embodiments, the PSS and SSS occupy a same number of RBs in frequency and wherein the PBCH occupies at least as many RBs in frequency as the PSS (or SSS). In one embodiment, the PBCH occupies one RB more than the PSS (or SSS) in frequency. In another embodiment, the PBCH occupies up to five RBs more than the PSS (or SSS) in frequency.

According to the above embodiments, each time domain symbol containing PBCH comprises a DMRS, where each DMRS sequence (e.g., in each of four PBCH symbols for SSB Type 3) is initiated with a different sequence (e.g., initialized with the four least significant bits of the SS index). In such embodiments, a portion of the SSB index (e.g., the three most significant bits) may be carried in PBCH payload, thus in total 128 SSB (i.e., 2\hat{ }7) indices can be coded.

In some embodiments, the PSS occupies a plurality of time domain symbols. In certain embodiments (e.g., to reduce the number of REs of the SSB structure), the PSS is configured with two or more sequences, with each sequence indicating a subset of cell IDs, where each sequence is transmitted in a different time domain symbol.

In some embodiments, a minimum bandwidth of a Type 0 Control Resource Set (“CORESET_0”) is set equal to the number of RBs in frequency of the SSB structure. In certain embodiments, the CORESET_0 occupies up to six OFDM symbols in the time domain, wherein the length of the CORESET_0 (in the time domain) is based on the SSB structure (i.e., based on the number of time-domain symbols the SSB occupies).

In some embodiments, the transceiver 1125 receives a configuration for a time pattern of SSB repetition. In certain embodiments, the configuration indicates a number of contiguous repetitions for an SSB using a same beam. In such embodiments, the number of contiguous repetitions for SSB may be based on a frequency range used by the first cell and/or on the subcarrier spacing of the first cell. In further embodiments, the configuration indicates a number of SSB block repetitions (e.g., continuous or non-contiguous), where each of the PSS, SSS, and PBCH within a particular SSB block is separately configured.

In some embodiments, a first time domain symbol of the SSB structure contains the PSS, wherein a second time domain symbol of the SSB structure contains the SSS. In some embodiments, the first OFDM symbol of the SSB structure (e.g., SSB Type 2 and/or SSB Type 3) contains the PSS, the second OFDM symbol of the SSB structure contains the PBCH, the third symbol of the SSB structure contains the SSS, and the remaining OFDM symbols of the SSB structure contain the PBCH.

In some embodiments, the SSB structure is associated with a high subcarrier spacing, e.g., greater than 240 kHz, where the first cell uses a high subcarrier spacing, e.g., greater than 240 kHz. In some embodiments, the transceiver 1125 receives a set of SSB within a beam sweep, wherein the set of SSB is confined to a 2.5 ms time interval.

The memory 1110, in one embodiment, is a computer readable storage medium. In some embodiments, the memory 1110 includes volatile computer storage media. For example, the memory 1110 may include a RAM, including dynamic RAM (“DRAM”), synchronous dynamic RAM (“SDRAM”), and/or static RAM (“SRAM”). In some embodiments, the memory 1110 includes non-volatile computer storage media. For example, the memory 1110 may include a hard disk drive, a flash memory, or any other suitable non-volatile computer storage device. In some embodiments, the memory 1110 includes both volatile and non-volatile computer storage media.

In some embodiments, the memory 1110 stores data related to enhanced SSB patterns and/or mobile operation. For example, the memory 1110 may store various parameters, panel/beam configurations, resource assignments, policies, and the like as described above. In certain embodiments, the memory 1110 also stores program code and related data, such as an operating system or other controller algorithms operating on the apparatus 1100.

The input device 1115, in one embodiment, may include any known computer input device including a touch panel, a button, a keyboard, a stylus, a microphone, or the like. In some embodiments, the input device 1115 may be integrated with the output device 1120, for example, as a touchscreen or similar touch-sensitive display. In some embodiments, the input device 1115 includes a touchscreen such that text may be input using a virtual keyboard displayed on the touchscreen and/or by handwriting on the touchscreen. In some embodiments, the input device 1115 includes two or more different devices, such as a keyboard and a touch panel.

The output device 1120, in one embodiment, is designed to output visual, audible, and/or haptic signals. In some embodiments, the output device 1120 includes an electronically controllable display or display device capable of outputting visual data to a user. For example, the output device 1120 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 1120 may include a wearable display separate from, but communicatively coupled to, the rest of the user equipment apparatus 1100, such as a smart watch, smart glasses, a heads-up display, or the like. Further, the output device 1120 may be a component of a smart phone, a personal digital assistant, a television, a table computer, a notebook (laptop) computer, a personal computer, a vehicle dashboard, or the like.

In certain embodiments, the output device 1120 includes one or more speakers for producing sound. For example, the output device 1120 may produce an audible alert or notification (e.g., a beep or chime). In some embodiments, the output device 1120 includes one or more haptic devices for producing vibrations, motion, or other haptic feedback. In some embodiments, all or portions of the output device 1120 may be integrated with the input device 1115. For example, the input device 1115 and output device 1120 may form a touchscreen or similar touch-sensitive display. In other embodiments, the output device 1120 may be located near the input device 1115.

The transceiver 1125 communicates with one or more network functions of a mobile communication network via one or more access networks. The transceiver 1125 operates under the control of the processor 1105 to transmit messages, data, and other signals and also to receive messages, data, and other signals. For example, the processor 1105 may selectively activate the transceiver 1125 (or portions thereof) at particular times in order to send and receive messages.

The transceiver 1125 includes at least transmitter 1130 and at least one receiver 1135. One or more transmitters 1130 may be used to provide UL communication signals to a base unit 121, such as the UL transmissions described herein. Similarly, one or more receivers 1135 may be used to receive DL communication signals from the base unit 121, as described herein. Although only one transmitter 1130 and one receiver 1135 are illustrated, the user equipment apparatus 1100 may have any suitable number of transmitters 1130 and receivers 1135. Further, the transmitter(s) 1130 and the receiver(s) 1135 may be any suitable type of transmitters and receivers. In one embodiment, the transceiver 1125 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1125, transmitters 1130, and receivers 1135 may be implemented as physically separate components that access a shared hardware resource and/or software resource, such as for example, the network interface 1140.

In various embodiments, one or more transmitters 1130 and/or one or more receivers 1135 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 1130 and/or one or more receivers 1135 may be implemented and/or integrated into a multi-chip module. In some embodiments, other components such as the network interface 1140 or other hardware components/circuits may be integrated with any number of transmitters 1130 and/or receivers 1135 into a single chip. In such embodiment, the transmitters 1130 and receivers 1135 may be logically configured as a transceiver 1125 that uses one more common control signals or as modular transmitters 1130 and receivers 1135 implemented in the same hardware chip or in a multi-chip module.

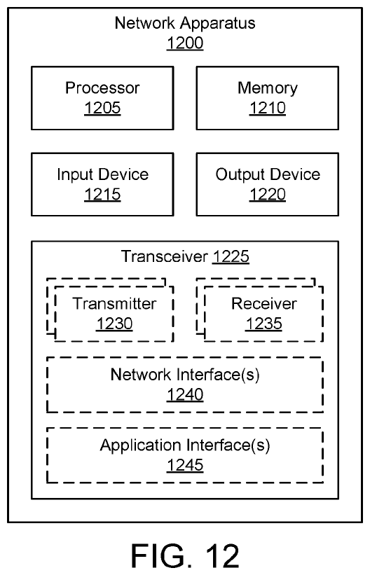

FIG. 12 depicts a network apparatus 1200 that may be used for SSB pattern enhancements, according to embodiments of the disclosure. In one embodiment, network apparatus 1200 may be one implementation of a RAN entity, such as the base unit 121 and/or the RAN node 205, as described above. Furthermore, the base network apparatus 1200 may include a processor 1205, a memory 1210, an input device 1215, an output device 1220, and a transceiver 1225.

In some embodiments, the input device 1215 and the output device 1220 are combined into a single device, such as a touchscreen. In certain embodiments, the network apparatus 1200 may not include any input device 1215 and/or output device 1220. In various embodiments, the network apparatus 1200 may include one or more of: the processor 1205, the memory 1210, and the transceiver 1225, and may not include the input device 1215 and/or the output device 1220.

As depicted, the transceiver 1225 includes at least one transmitter 1230 and at least one receiver 1235. Here, the transceiver 1225 communicates with one or more remote units 105. Additionally, the transceiver 1225 may support at least one network interface 1240 and/or application interface 1245. The application interface(s) 1245 may support one or more APIs. The network interface(s) 1240 may support 3GPP reference points, such as Uu, N1, N2 and N3. Other network interfaces 1240 may be supported, as understood by one of ordinary skill in the art.

The processor 1205, in one embodiment, may include any known controller capable of executing computer-readable instructions and/or capable of performing logical operations. For example, the processor 1205 may be a microcontroller, a microprocessor, a CPU, a GPU, an auxiliary processing unit, a FPGA, or similar programmable controller. In some embodiments, the processor 1205 executes instructions stored in the memory 1210 to perform the methods and routines described herein. The processor 1205 is communicatively coupled to the memory 1210, the input device 1215, the output device 1220, and the transceiver 1225.

In various embodiments, the network apparatus 1200 is a RAN node (e.g., gNB) that communicates with one or more UEs, as described herein. In such embodiments, the processor 1205 controls the network apparatus 1200 to perform the above described RAN behaviors. When operating as a RAN node, the processor 1205 may include an application processor (also known as “main processor”) which manages application-domain and operating system (“OS”) functions and a baseband processor (also known as “baseband radio processor”) which manages radio functions.

In various embodiments, the processor 1205 controls the transceiver 1225 (i.e., implementing a radio interface) to transmit a SSB structure comprising more than four symbols (i.e., in the time domain). Here, the SSB structure includes at least one time domain symbol for each of a PSS and an SSS. The SSB structure also includes multiple time domain symbols for a PBCH. The transceiver 1225 receives a connection request from a UE. In various embodiments, the processor 1205 provides a first cell (e.g., via the transceiver 1225), where the UE's connection request initiates connection to the first cell.

In some embodiments, the SSB structure (e.g., SSB Type 2) occupies five OFDM symbols in the time domain, and 192 REs in the frequency domain, where the SSB structure contains one OFDM symbol for the PSS, one OFDM symbol for the SSS, and three OFDM symbols for the PBCH.

In some embodiments, the SSB structure (i.e., SSB Type 3) occupies six OFDM symbols in the time domain, and 144 resource elements in the frequency domain, where the SSB structure contains one OFDM symbol for the PSS, one OFDM symbol for the SSS, and four OFDM symbols for the PBCH.

According to the above embodiments, the PSS and SSS occupy a same number of RBs in frequency and the PBCH occupies at least as many RBs in frequency as the PSS (or SSS). In one embodiment, the PBCH occupies one RB more than the PSS (or SSS) in frequency. In another embodiment, the PBCH occupies up to five RBs more than the PSS (or SSS) in frequency.

According to the above embodiments, each time domain symbol containing PBCH comprises a DMRS, where each DMRS sequence (e.g., in each of four PBCH symbols for SSB Type 3) is initiated with a different sequence (e.g., initialized with the four least significant bits of the SS index). In such embodiments, a portion of the SSB index (e.g., the three most significant bits) may be carried in PBCH payload, thus in total 128 SSB (i.e., 2\hat{ }7) indices can be coded.

In some embodiments, the PSS occupies a plurality of time domain symbols. In certain embodiments (e.g., to reduce the number of REs of the SSB structure), the PSS is configured with two or more sequences, with each sequence indicating a subset of cell IDs, where each sequence is transmitted in a different time domain symbol.

In some embodiments, a minimum bandwidth of a CORESET_0 is set equal to the number of RBs in frequency of the SSB structure. In certain embodiments, the CORESET_0 occupies up to six OFDM symbols in the time domain, wherein the length of the CORESET_0 (in the time domain) is based on the SSB structure (i.e., based on the number of time-domain symbols the SSB occupies).

In some embodiments, the transceiver 1225 transmits a configuration to the UE for a time pattern of SSB repetition. In certain embodiments, the configuration indicates a number of contiguous repetitions for an SSB using a same beam. In such embodiments, the number of contiguous repetitions for SSB may be based on a frequency range used by the first cell and/or on the subcarrier spacing of the first cell. In further embodiments, the configuration indicates a number of SSB block repetitions (e.g., continuous or non-contiguous), where each of the PSS, SSS, and PBCH within a particular SSB block is separately configured.

In some embodiments, a first time domain symbol of the SSB structure contains the PSS, wherein a second time domain symbol of the SSB structure contains the SSS. In some embodiments, the first OFDM symbol of the SSB structure (e.g., SSB Type 2 and/or SSB Type 3) contains the PSS, the second OFDM symbol of the SSB structure contains the PBCH, the third symbol of the SSB structure contains the SSS, and the remaining OFDM symbols of the SSB structure contain the PBCH.

In some embodiments, the SSB structure is associated with a subcarrier spacing greater than 240 kHz, where the first cell uses a subcarrier spacing greater than 240 kHz. In some embodiments, the transceiver 1225 transmits a set of SSB within a beam sweep, wherein the set of SSB is confined to a 2.5 ms time interval.

The memory 1210, in one embodiment, is a computer readable storage medium. In some embodiments, the memory 1210 includes volatile computer storage media. For example, the memory 1210 may include a RAM, including dynamic RAM (“DRAM”), synchronous dynamic RAM (“SDRAM”), and/or static RAM (“SRAM”). In some embodiments, the memory 1210 includes non-volatile computer storage media. For example, the memory 1210 may include a hard disk drive, a flash memory, or any other suitable non-volatile computer storage device. In some embodiments, the memory 1210 includes both volatile and non-volatile computer storage media.

In some embodiments, the memory 1210 stores data related to enhanced SSB patterns and/or mobile operation. For example, the memory 1210 may store parameters, configurations, resource assignments, policies, and the like, as described above. In certain embodiments, the memory 1210 also stores program code and related data, such as an operating system or other controller algorithms operating on the apparatus 1200.

The input device 1215, in one embodiment, may include any known computer input device including a touch panel, a button, a keyboard, a stylus, a microphone, or the like. In some embodiments, the input device 1215 may be integrated with the output device 1220, for example, as a touchscreen or similar touch-sensitive display. In some embodiments, the input device 1215 includes a touchscreen such that text may be input using a virtual keyboard displayed on the touchscreen and/or by handwriting on the touchscreen. In some embodiments, the input device 1215 includes two or more different devices, such as a keyboard and a touch panel.

The output device 1220, in one embodiment, is designed to output visual, audible, and/or haptic signals. In some embodiments, the output device 1220 includes an electronically controllable display or display device capable of outputting visual data to a user. For example, the output device 1220 may include, but is not limited to, an LCD display, an LED display, an OLED display, a projector, or similar display device capable of outputting images, text, or the like to a user. As another, non-limiting, example, the output device 1220 may include a wearable display separate from, but communicatively coupled to, the rest of the network apparatus 1200, such as a smart watch, smart glasses, a heads-up display, or the like. Further, the output device 1220 may be a component of a smart phone, a personal digital assistant, a television, a table computer, a notebook (laptop) computer, a personal computer, a vehicle dashboard, or the like.

In certain embodiments, the output device 1220 includes one or more speakers for producing sound. For example, the output device 1220 may produce an audible alert or notification (e.g., a beep or chime). In some embodiments, the output device 1220 includes one or more haptic devices for producing vibrations, motion, or other haptic feedback. In some embodiments, all or portions of the output device 1220 may be integrated with the input device 1215. For example, the input device 1215 and output device 1220 may form a touchscreen or similar touch-sensitive display. In other embodiments, the output device 1220 may be located near the input device 1215.

The transceiver 1225 includes at least transmitter 1230 and at least one receiver 1235. One or more transmitters 1230 may be used to communicate with the UE, as described herein. Similarly, one or more receivers 1235 may be used to communicate with network functions in the PLMN and/or RAN, as described herein. Although only one transmitter 1230 and one receiver 1235 are illustrated, the network apparatus 1200 may have any suitable number of transmitters 1230 and receivers 1235. Further, the transmitter(s) 1230 and the receiver(s) 1235 may be any suitable type of transmitters and receivers.

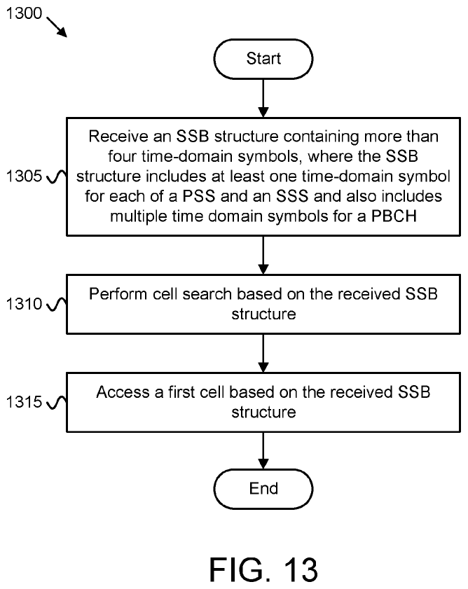

FIG. 13 depicts one embodiment of a method 1300 for SSB pattern enhancements, according to embodiments of the disclosure. In various embodiments, the method 1300 is performed by a user equipment device, such as the remote unit 105, the UE 205, and/or the user equipment apparatus 1100, as described above. In some embodiments, the method 1300 is performed by a processor, such as a microcontroller, a microprocessor, a CPU, a GPU, an auxiliary processing unit, a FPGA, or the like.

The method 1300 begins and receives 1305 a SSB structure comprising more than four time domain symbols. Here, the SSB structure includes at least one time domain symbol for each of a PSS and an SSS. The SSB structure also includes multiple time domain symbols for a PBCH. The method 1300 includes performing 1310 cell search based on the received SSB structure. The method 1300 includes accessing 1315 (i.e., connecting to) a first cell based on the received SSB structure. The method 1300 ends.

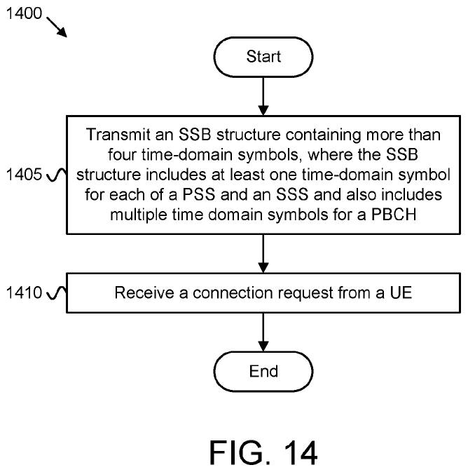

FIG. 14 depicts one embodiment of a method 1400 for SSB pattern enhancements, according to embodiments of the disclosure. In various embodiments, the method 1400 is performed by a RAN device, such as the base unit 121, the RAN node 210 and/or the network apparatus 1200, as described above. In some embodiments, the method 1400 is performed by a processor, such as a microcontroller, a microprocessor, a CPU, a GPU, an auxiliary processing unit, a FPGA, or the like.

The method 1400 begins and transmits 1405 a SSB structure containing more than four symbols in the time domain. Here, the SSB structure includes at least one time domain symbol for each of a PSS and an SSS. The SSB structure also includes multiple time domain symbols for a PBCH. The method 1400 includes receiving 1410 a connection request from a UE. The method 1400 ends.

Disclosed herein is a first apparatus for SSB pattern enhancements, according to embodiments of the disclosure. The first apparatus may be implemented by a UE device, such as the remote unit 105, the UE 205, and/or the user equipment apparatus 1100, described above. The first apparatus includes a processor and a transceiver (i.e., implementing a radio interface) that receives a Synchronization Signal/Physical Broadcast Channel Block (“SSB”) structure comprising more than four time domain symbols. Here, the SSB structure includes at least one time domain symbol for each of a PSS and an SSS. The SSB structure also includes multiple time domain symbols for a PBCH. The processor performs cell search based on the received SSB structure and accesses (i.e., connects to) a first cell based on the received SSB structure.

In some embodiments, the SSB structure (e.g., SSB Type 2) occupies five OFDM symbols in the time domain, and 192 REs in the frequency domain, where the SSB structure contains one OFDM symbol for the PSS, one OFDM symbol for the SSS, and three OFDM symbols for the PBCH.

In some embodiments, the SSB structure (i.e., SSB Type 3) occupies six OFDM symbols in the time domain, and 144 resource elements in the frequency domain, where the SSB structure contains one OFDM symbol for the PSS, one OFDM symbol for the SSS, and four OFDM symbols for the PBCH.

According to the above embodiments, the PSS and SSS occupy a same number of RBs in frequency and the PBCH occupies at least as many RBs in frequency as the PSS (or SSS). In one embodiment, the PBCH occupies one RB more than the PSS (or SSS) in frequency. In another embodiment, the PBCH occupies up to five RBs more than the PSS (or SSS) in frequency.

According to the above embodiments, each time domain symbol containing PBCH comprises a DMRS, where each DMRS sequence (e.g., in each of four PBCH symbols for SSB Type 3) is initiated with a different sequence. In such embodiments, a portion of the SSB index may be carried in PBCH payload.

In some embodiments, the PSS occupies a plurality of time domain symbols. In certain embodiments (e.g., to reduce the number of REs of the SSB structure), the PSS is configured with two or more sequences, with each sequence indicating a subset of cell IDs, where each sequence is transmitted in a different time domain symbol.

In some embodiments, a minimum bandwidth of a CORESET_0 is set equal to the number of RBs in frequency of the SSB structure. In certain embodiments, the CORESET_0 occupies up to six OFDM symbols in the time domain, wherein the length of the CORESET_0 (in the time domain) is based on the SSB structure.

In some embodiments, the transceiver receives a configuration for a time pattern of SSB repetition. In certain embodiments, the configuration indicates a number of contiguous repetitions for an SSB using a same beam. In such embodiments, the number of contiguous repetitions for SSB may be based on a frequency range used by the first cell and/or on the subcarrier spacing of the first cell. In further embodiments, the configuration indicates a number of SSB block repetitions (e.g., continuous or non-contiguous), where each of the PSS, SSS, and PBCH within a particular SSB block is separately configured.

In some embodiments, a first time domain symbol of the SSB structure contains the PSS, wherein a second time domain symbol of the SSB structure contains the SSS. In some embodiments, the first OFDM symbol of the SSB structure (e.g., SSB Type 2 and/or SSB Type 3) contains the PSS, the second OFDM symbol of the SSB structure contains the PBCH, the third symbol of the SSB structure contains the SSS, and the remaining OFDM symbols of the SSB structure contain the PBCH.

In some embodiments, the SSB structure is associated with a subcarrier spacing greater than 240 kHz, where the first cell uses a subcarrier spacing greater than 240 kHz. In some embodiments, the transceiver receives a set of SSB within a beam sweep, wherein the set of SSB is confined to a 2.5 ms time interval.

Disclosed herein is a first method for calculating an EVM of a transmitter, according to embodiments of the disclosure. The first method may be performed by a UE device, such as the remote unit 105, the UE 205, and/or the user equipment apparatus 1100, described above. The first method includes receiving a SSB structure comprising more than four time domain symbols. Here, the SSB structure includes at least one time domain symbol for each of a PSS and an SSS. The SSB structure also includes multiple time domain symbols for a PBCH. The first method includes performing cell search based on the received SSB structure and accessing (i.e., connecting to) a first cell based on the received SSB structure.

In some embodiments, the SSB structure (e.g., SSB Type 2) occupies five OFDM symbols in the time domain, and 192 REs in the frequency domain, where the SSB structure contains one OFDM symbol for the PSS, one OFDM symbol for the SSS, and three OFDM symbols for the PBCH.

In some embodiments, the SSB structure (i.e., SSB Type 3) occupies six OFDM symbols in the time domain, and 144 resource elements in the frequency domain, where the SSB structure contains one OFDM symbol for the PSS, one OFDM symbol for the SSS, and four OFDM symbols for the PBCH.

According to the above embodiments, the PSS and SSS occupy a same number of RBs in frequency and the PBCH occupies at least as many RBs in frequency as the PSS (or SSS). In one embodiment, the PBCH occupies one RB more than the PSS (or SSS) in frequency. In another embodiment, the PBCH occupies up to five RBs more than the PSS (or SSS) in frequency.

According to the above embodiments, each time domain symbol containing PBCH comprises a DMRS, where each DMRS sequence (e.g., in each of four PBCH symbols for SSB Type 3) is initiated with a different sequence. In such embodiments, a portion of the SSB index may be carried in PBCH payload.

In some embodiments, the PSS occupies a plurality of time domain symbols. In certain embodiments (e.g., to reduce the number of REs of the SSB structure), the PSS is configured with two or more sequences, with each sequence indicating a subset of cell IDs, where each sequence is transmitted in a different time domain symbol.

In some embodiments, a minimum bandwidth of a CORESET_0 is set equal to the number of RBs in frequency of the SSB structure. In certain embodiments, the CORESET_0 occupies up to six OFDM symbols in the time domain, wherein the length of the CORESET_0 (in the time domain) is based on the SSB structure.

In some embodiments, the first method includes receiving a configuration for a time pattern of SSB repetition. In certain embodiments, the configuration indicates a number of contiguous repetitions for an SSB using a same beam. In such embodiments, the number of contiguous repetitions for SSB may be based on a frequency range used by the first cell and/or on the subcarrier spacing of the first cell. In further embodiments, the configuration indicates a number of SSB block repetitions (e.g., continuous or non-contiguous), where each of the PSS, SSS, and PBCH within a particular SSB block is separately configured.

In some embodiments, a first time domain symbol of the SSB structure contains the PSS, wherein a second time domain symbol of the SSB structure contains the SSS. In some embodiments, the first OFDM symbol of the SSB structure (e.g., SSB Type 2 and/or SSB Type 3) contains the PSS, the second OFDM symbol of the SSB structure contains the PBCH, the third symbol of the SSB structure contains the SSS, and the remaining OFDM symbols of the SSB structure contain the PBCH.

In some embodiments, the SSB structure is associated with a subcarrier spacing greater than 240 kHz, where the first cell uses a subcarrier spacing greater than 240 kHz. In some embodiments, the first method includes receiving a set of SSB within a beam sweep, wherein the set of SSB is confined to a 2.5 ms time interval.

Disclosed herein is a second apparatus for SSB pattern enhancements, according to embodiments of the disclosure. The second apparatus may be implemented by a device in a radio access network (“RAN”), such as the base unit 121, the RAN node 210, and/or the network apparatus 1200, described above. The second apparatus includes a processor and a transceiver (i.e., implementing a radio interface) that transmits a SSB structure comprising more than four symbols (i.e., in the time domain). Here, the SSB structure includes at least one time domain symbol for each of a PSS and an SSS. The SSB structure also includes multiple time domain symbols for a PBCH. The transceiver receives a connection request from a UE.

In some embodiments, the SSB structure (e.g., SSB Type 2) occupies five OFDM symbols in the time domain, and 192 REs in the frequency domain, where the SSB structure contains one OFDM symbol for the PSS, one OFDM symbol for the SSS, and three OFDM symbols for the PBCH.

In some embodiments, the SSB structure (i.e., SSB Type 3) occupies six OFDM symbols in the time domain, and 144 resource elements in the frequency domain, where the SSB structure contains one OFDM symbol for the PSS, one OFDM symbol for the SSS, and four OFDM symbols for the PBCH.

According to the above embodiments, the PSS and SSS occupy a same number of RBs in frequency and the PBCH occupies at least as many RBs in frequency as the PSS (or SSS). In one embodiment, the PBCH occupies one RB more than the PSS (or SSS) in frequency. In another embodiment, the PBCH occupies up to five RBs more than the PSS (or SSS) in frequency.

According to the above embodiments, each time domain symbol containing PBCH comprises a DMRS, where each DMRS sequence (e.g., in each of four PBCH symbols for SSB Type 3) is initiated with a different sequence. In such embodiments, a portion of the SSB index may be carried in PBCH payload.

In some embodiments, the PSS occupies a plurality of time domain symbols. In certain embodiments (e.g., to reduce the number of REs of the SSB structure), the PSS is configured with two or more sequences, with each sequence indicating a subset of cell IDs, where each sequence is transmitted in a different time domain symbol.

In some embodiments, a minimum bandwidth of a CORESET_0 is set equal to the number of RBs in frequency of the SSB structure. In certain embodiments, the CORESET_0 occupies up to six OFDM symbols in the time domain, wherein the length of the CORESET_0 (in the time domain) is based on the SSB structure.

In some embodiments, the transceiver transmits a configuration to the UE for a time pattern of SSB repetition. In certain embodiments, the configuration indicates a number of contiguous repetitions for an SSB using a same beam. In such embodiments, the number of contiguous repetitions for SSB may be based on a frequency range used by the first cell and/or on the subcarrier spacing of the first cell. In further embodiments, the configuration indicates a number of SSB block repetitions (e.g., continuous or non-contiguous), where each of the PSS, SSS, and PBCH within a particular SSB block is separately configured.

In some embodiments, a first time domain symbol of the SSB structure contains the PSS, wherein a second time domain symbol of the SSB structure contains the SSS. In some embodiments, the first OFDM symbol of the SSB structure (e.g., SSB Type 2 and/or SSB Type 3) contains the PSS, the second OFDM symbol of the SSB structure contains the PBCH, the third symbol of the SSB structure contains the SSS, and the remaining OFDM symbols of the SSB structure contain the PBCH.

In some embodiments, the SSB structure is associated with a subcarrier spacing greater than 240 kHz, where the first cell uses a subcarrier spacing greater than 240 kHz. In some embodiments, the transceiver transmits a set of SSB within a beam sweep, wherein the set of SSB is confined to a 2.5 ms time interval.

Disclosed herein is a second method for SSB pattern enhancements, according to embodiments of the disclosure. The second method may be performed by a device in a RAN, such as the base unit 121, the RAN node 210, and/or the network apparatus 1200, described above. The second method includes transmitting a SSB structure containing more than four symbols in the time domain. Here, the SSB structure includes at least one time domain symbol for each of a PSS and an SSS. The SSB structure also includes multiple time domain symbols for a PBCH. The second method include receiving a connection request from a UE.

In some embodiments, the SSB structure (e.g., SSB Type 2) occupies five OFDM symbols in the time domain, and 192 REs in the frequency domain, where the SSB structure contains one OFDM symbol for the PSS, one OFDM symbol for the SSS, and three OFDM symbols for the PBCH.

In some embodiments, the SSB structure (i.e., SSB Type 3) occupies six OFDM symbols in the time domain, and 144 resource elements in the frequency domain, where the SSB structure contains one OFDM symbol for the PSS, one OFDM symbol for the SSS, and four OFDM symbols for the PBCH.

According to the above embodiments, the PSS and SSS occupy a same number of RBs in frequency and the PBCH occupies at least as many RBs in frequency as the PSS (or SSS). In one embodiment, the PBCH occupies one RB more than the PSS (or SSS) in frequency. In another embodiment, the PBCH occupies up to five RBs more than the PSS (or SSS) in frequency.

According to the above embodiments, each time domain symbol containing PBCH comprises a DMRS, where each DMRS sequence (e.g., in each of four PBCH symbols for SSB Type 3) is initiated with a different sequence. In such embodiments, a portion of the SSB index may be carried in PBCH payload.

In some embodiments, the PSS occupies a plurality of time domain symbols. In certain embodiments (e.g., to reduce the number of REs of the SSB structure), the PSS is configured with two or more sequences, with each sequence indicating a subset of cell IDs, where each sequence is transmitted in a different time domain symbol.

In some embodiments, a minimum bandwidth of a CORESET_0 is set equal to the number of RBs in frequency of the SSB structure. In certain embodiments, the CORESET_0 occupies up to six OFDM symbols in the time domain, wherein the length of the CORESET_0 (in the time domain) is based on the SSB structure.

In some embodiments, the second method includes transmitting a configuration to the UE for a time pattern of SSB repetition. In certain embodiments, the configuration indicates a number of contiguous repetitions for an SSB using a same beam. In such embodiments, the number of contiguous repetitions for SSB may be based on a frequency range used by the first cell and/or on the subcarrier spacing of the first cell. In further embodiments, the configuration indicates a number of SSB block repetitions (e.g., continuous or non-contiguous), where each of the PSS, SSS, and PBCH within a particular SSB block is separately configured.

In some embodiments, a first time domain symbol of the SSB structure contains the PSS, wherein a second time domain symbol of the SSB structure contains the SSS. In some embodiments, the first OFDM symbol of the SSB structure (e.g., SSB Type 2 and/or SSB Type 3) contains the PSS, the second OFDM symbol of the SSB structure contains the PBCH, the third symbol of the SSB structure contains the SSS, and the remaining OFDM symbols of the SSB structure contain the PBCH.

In some embodiments, the SSB structure is associated with a subcarrier spacing greater than 240 kHz, where the first cell uses a subcarrier spacing greater than 240 kHz. In some embodiments, the second method includes transmitting a set of SSB within a beam sweep, wherein the set of SSB is confined to a 2.5 ms time interval.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1.-15. (canceled)

16. A User Equipment (“UE”) apparatus comprising:
a processor; and
a memory coupled to the processor, the memory comprising instruction executable by the processor to cause the apparatus to:
receive a Synchronization Signal/Physical Broadcast Channel Block (“SSB”) structure comprising more than four time-domain symbols,
wherein the SSB structure includes at least one time-domain symbol for each of: a Primary Synchronization Signal (“PSS”) and a Secondary Synchronization Signal (“SSS”) and includes multiple time-domain symbols for a Physical Broadcast Channel (“PBCH”);
perform cell search based on the received SSB structure; and
access a first cell based on the received SSB structure.

17. The apparatus of claim 16, wherein the SSB structure occupies five Orthogonal Frequency Division Multiplexing (“OFDM”) symbols in the time domain, and 192 resource elements in the frequency domain, wherein the SSB structure comprises one OFDM symbol for the PSS, one OFDM symbol for the SSS, and three OFDM symbols for the PBCH.

18. The apparatus of claim 17, wherein the PSS and SSS occupy a same number of Resource Blocks (“RBs”) in frequency and wherein the PBCH occupies at least as many RBs in frequency as the PSS.

19. The apparatus of claim 17, wherein each time-domain symbol containing PBCH comprises a Demodulation Reference Signal (“DMRS”) and wherein each DMRS sequence is initiated with a different sequence.

20. The apparatus of claim 16, wherein the SSB structure occupies six Orthogonal Frequency Division Multiplexing (“OFDM”) symbols in the time domain, and 144 resource elements in the frequency domain, wherein the SSB structure comprises one OFDM symbol for the PSS, one OFDM symbol for the SSS, and four OFDM symbols for the PBCH.

21. The apparatus of claim 20, wherein the PSS and SSS occupy a same number of Resource Blocks (“RBs”) in frequency and wherein the PBCH occupies at least as many RBs in frequency as the PSS.

22. The apparatus of claim 20, wherein each time-domain symbol containing PBCH comprises a Demodulation Reference Signal (“DMRS”) and wherein each DMRS sequence is initiated with a different sequence.

23. The apparatus of claim 16, wherein the PSS occupies a plurality of time-domain symbols.

24. The apparatus of claim 23, wherein the PSS is configured with two or more sequences, with each sequence indicating a subset of cell identifiers, and wherein each sequence is transmitted in a different time-domain symbol.

25. The apparatus of claim 16, wherein a minimum bandwidth of a Type 0 Control Resource Set (“CORESET_0”) is set equal to a number of Resource Blocks (“RBs”) in frequency of the SSB structure.

26. The apparatus of claim 25, wherein the CORESET_0 occupies up to 6 Orthogonal Frequency Division Multiplexing (“OFDM”) symbols in the time-domain, wherein a length of the CORESET_0 is based on the SSB structure.

27. The apparatus of claim 16, further comprising receiving a configuration for a time pattern of SSB repetition, the configuration indicating a number of contiguous repetitions for an SSB using a same beam.

28. The apparatus of claim 27, wherein the number of contiguous repetitions for SSB based on a frequency range used by the first cell and/or a subcarrier spacing of the first cell.

29. The apparatus of claim 16, further comprising receiving a configuration for a time pattern of SSB repetition, the configuration indicating a number of repetitions for each of the PSS, SSS, and PBCH within a particular SSB block is separately configured.

30. The apparatus of claim 16, wherein a first time-domain symbol of the SSB structure contains the PSS, wherein a second time-domain symbol of the SSB structure contains the SSS.

31. A method of a User Equipment (“UE”), the method comprising:
receiving a Synchronization Signal/Physical Broadcast Channel Block (“SSB”) structure comprising more than four time-domain symbols,
wherein the SSB structure includes at least one time-domain symbol for each of: a Primary Synchronization Signal (“PSS”) and a Secondary Synchronization Signal (“SSS”) and includes multiple time-domain symbols for a Physical Broadcast Channel (“PBCH”);
performs cell search based on the received SSB structure; and
accessing a first cell based on the received SSB structure.

32. A Radio Access Network (“RAN”) apparatus comprising:
a processor; and
a memory coupled to the processor, the memory comprising instruction executable by the processor to cause the apparatus to:
transmit a Synchronization Signal/Physical Broadcast Channel Block (“SSB”) structure comprising more than four symbols in the time domain,
wherein the SSB structure includes at least one symbol for each of: a Primary Synchronization Signal (“PSS”) and a Secondary Synchronization Signal (“SSS”) and includes multiple symbols for a Physical Broadcast Channel (“PBCH”); and
receive a connection request from a User Equipment (“UE”).

33. The apparatus of claim 32, wherein the SSB structure occupies five Orthogonal Frequency Division Multiplexing (“OFDM”) symbols in the time domain, and 192 resource elements in the frequency domain, wherein the SSB structure comprises one OFDM symbol for the PSS, one OFDM symbol for the SSS, and three OFDM symbols for the PBCH.

34. The apparatus of claim 32, wherein the SSB structure occupies six Orthogonal Frequency Division Multiplexing (“OFDM”) symbols in the time domain, and 144 resource elements in the frequency domain, wherein the SSB structure comprises one OFDM symbol for the PSS, one OFDM symbol for the SSS, and four OFDM symbols for the PBCH.

35. The apparatus of claim 32, wherein the PSS occupies a plurality of time-domain symbols, wherein the PSS is configured with two or more sequences, with each sequence indicating a subset of cell identifiers, and wherein each sequence is transmitted in a different time-domain symbol.
